(19) United States
(12) Patent Application Publication
(10) Pub. No.: US 2002/0018066 A1
(43) Pub. Date: Feb. 14, 2002

(54) System and method for a dynamic professional syllabus

(76) Inventor: Amos Vizer, Hod Hasharon (IL)

Correspondence Address: DR. MARK FRIEDMAN LTD., c/o Bill Polkinghorn - Discovery Dispatch, 9003 Florin Way, Upper Marlboro, MD, 20772, US

(21) Appl. No.: 09/897,959

(22) Filed: Jul. 5, 2001

Related U.S. Application Data
(60) Provisional application No. 60/216,377, filed on Jul. 5, 2000.

(51) Int. Cl. G06T 17/00

(52) U.S. Cl. 345/428

(57) ABSTRACT

The present invention relates to an integrated professional information server and, in particular, it concerns a inter or intra-net system to coordinate professional learning, organization, information, and communication needs, generate and communicate a syllabus containing a program of missions. Exercises strengthen a professional's proficiency and knowledge in at least one topic. Preferentially the syllabus automatically presents at least one trainee with appropriate exercises, controls support materials, and tracks progress. An on-line real time graphical simulation algorithm facilitates simulations of real localities.

### FIELD AND BACKGROUND OF THE INVENTION

The present invention relates to an integrated professional information server and, in particular, it concerns a inter or intra-net system to coordinate professional learning, organization, information, and communication needs, generate and communicate a syllabus containing a program of missions. Exercises strengthen a professional's proficiency and knowledge in at least one topic. Preferentially the syllabus automatically presents at least one trainee with appropriate exercises, controls support materials, and tracks progress. An on-line real time graphical simulation algorithm facilitates simulations of real localities.

A significant problem in many technologically based organizations is the coordination of technical resources. These resources include trained staff, equipment and information. Along with traditional logistical responsibilities of scheduling and delivering equipment and operators, today's administrators are also faced with the task of updating the training and knowledge of personnel and the state of technical equipment. This is a formidable task due to the complexity of technology and the rapid pace of technical change. Often, administrators cannot understand the knowledge and skills needs of technical workers. Furthermore, technical personnel may work in intertwined crews or teams necessitating coordinated organization of training of various crewmembers in complimentary technologies.

There is therefore a need for a system to coordinate and inform technical workers, experts in particular aspects of technical knowledge and supervisors of large organizations. The system would disseminate and update new technical information, track the knowledge and skills of workers, and track physical resources.

Effective training often requires expensive resources including skilled instructors, expensive simulation apparatus, and valuable equipment for instructional practice.

For example, new aviation technologies are constantly being developed. Pilots must reliably master new technologies. A pilot must, therefore, perform flight training. Flight training is expensive because it requires valuable time of a trainee pilot and an instructor as well as expensive simulation equipment or aircraft and fuel. Pilots must also be constantly informed and trained for new equipment, flying conditions and laws and local conditions all over the world. Keeping abreast of the information involved requires the input of legal experts, technical experts, the pilots themselves and legal or geographical advisors all over the world. Furthermore, a pilot must have access to advanced equipment, and an aircrew and a ground crew with correspondingly advanced training.

During flight training, each trainee has his own personal learning curve. Each personal learning curve is composed of several consequent slopes that represent different topics in the training curriculum. Normally, during a training flight, several resources limit the trainee (e.g. time, number of topics to be covered, portion of topic within a session) and define the framework for feedback attainment. This is also true in simulated training flights that have a predetermined uniform training program. In both cases, training programs are not tailored to the individual trainee, making learning inefficient.

A typical training syllabus includes several sessions, and each session is used to train several topics. Because of this rigid structure, further training on a topic requires that the trainee take the entire session again, including topics already mastered. This represents a waste of valuable resources.

Highly skilled instructors often spend a large portion of time planning and training sessions. Paying technical experts to write lesson plans is expensive and inefficient.

Digital terrain modules are often used to create synthetic environments in simulation programs. These modules are based on geographic data of large areas. The modules contain a ‘height map’ based on information on ground level and variance. The size of height map files, especially for larger geographical areas, can be 100 s of megabytes.

Real Time 3D rendering engines for displaying terrain in a simulation program, use a representation that is made out of polygons. In order to accomplish this, the height map must be converted into a collection of neighboring polygons, commonly referred to as a polygon mesh. This conversion process is called meshing. When a map is to be viewed at varying levels of detail (LOD), a different mesh needs to be made for each LOD.

Currently, meshing is part of off line terrain production. During production, a collection of varying LOD meshes is compressed into a file. Each mesh is fixed, and cannot be modified. During a flight simulation a rendering engine accesses and loads the stored meshes. The maximum LOD requirement of rendering determines the minimum LOD of the mesh to be loaded. When an application needs to use a terrain with a higher resolution than available in the file, the meshing process must be repeated to produce a new mesh file.

A given mesh file may have details not visible to the viewer in the projection required. Rendering such a mesh in such a projection requires black facing non-visible details. The recalling of unnecessary details and then the black facing of those details wastes memory and processor resources thus slowing down the meshing process. Similarly, a viewer perceives high detail in some locations and little detail in other locations. Loading a large high detail mesh for an entire scene because a viewer needs high resolution in a particular location is inefficient.

Jenkins (U.S. Pat. No. 6,028,608) teaches a method to determine dynamically LOD perceivable to a viewer at various locations in a scene. Jenkins '608 does not reveal a method by which a computer is to change a mesh at various locations in the scene according to the changing perception of the viewer.

Previous art methods for dynamic meshing are based on hierarchal maps. A hierarchal map contains data at all levels of detail in data trees that are expanded or collapsed on need. Polygons or vertexes pertaining to details that are not visible always remain in memory. Examples of methods for dynamic meshing based on hierarchal vertex trees are Hoppe U.S. (Pat. Nos. 6,137,492 and 6,108,006) and Migdal et al. (U.S. Pat. No. 6,028,608). Hierarchal vertex tree methods require that the mesh always include the entire domain. Detailed data on all possible vertexes at the highest possible resolution remain in storage and are accessed according to a data tree. As such Hierarchal vertex trees are fast for dynamic rendering of computer graphics because hierarchal vertex trees do not require the defining new vertices on line. Full-scale hierarchal vertex trees alone are not efficient for rendering a very small portion of a large map because large invisible portion of the mesh remains constantly in memory. Also, hierarchical trees must be built off line from geometric data. The building of efficient hierarchal vertex trees often require expert personnel.

Thus, Hierarchal vertex trees alone are not suited for rendering in flight simulation because flight simulators generally render a small portion of a large-scale map for which Hierarchal vertex trees are inefficient. Furthermore, in military flight simulation, trainers may not wish to distribute secret military maps to an off site team of graphics experts for the sake of building a hierarchal vertex tree.

There is thus a widely recognized need for more efficient training practices. It would be highly advantageous to have a system and method that will facilitate information dissemination and speedy reliable training and retraining of personnel with minimum investment in training equipment and teaching hours. The current invention addresses this need by multi-level association and coordinating of knowledge and scheduling. The current invention also reveals an innovative system and method of adaptive real time triangulation for progressive meshing to increase the efficiency of training simulations. The present invention maximizes equipment access, saves trainee and instructor time, and facilitates realistic simulation to increase the speed and reliability of professional training, coordination and information dissemination.

### SUMMARY OF THE INVENTION

The present invention is of a dynamic professional syllabus which can be used to make training programs more efficient. Specifically, the present invention can be used to conserve training resources by tailoring teaching to trainee progress. Preferentially the syllabus automatically presents at least one trainee with appropriate exercises, controls support materials, and tracks progress. An on-line real time graphical simulation algorithm facilitates simulations of real localities.

According to the teachings of the present invention there is provided, a system for generating a syllabus for a trainee, the system includes a database. The database contains at least one topic and at least one topic attribute. The system also includes a processor in communication with the database. The processor is configured to generate the syllabus based on the topic and topic attribute. The system also contains an input interface capable of communicating with the processor and an output interface capable of communicating with the processor.

The input interface may include but is not limited to a personal computer, a formatted evaluation, an output channel of a training simulator, a medical database for example records made available by an insurance company, a psychological database, a data collection device of a vehicle, a device measuring the performance of a vehicle, a voice communication device, an automated test reader, a personal digital assistant, a recording device, a scanner, or an e-mail message.

The output interface may include but is not limited to a video viewer, a training simulator, a training simulator control channel, voice instructions, a communication channel of a training vehicle, a control channel of a training vehicle, a printer, a personal digital assistant, an e-mail message, and a personal computer.

The topic attribute may include but is not limited to a topic level, an order in which the topics are to be covered, an exercise to train the topic, a prerequisite to performing the exercise, an estimated time needed by a typical trainee to complete the exercise, a resource required for the exercise, a resource availability, a budget information, a requisite for successful completion of the topic, or a requisite for successful completion of the exercise.

The processor may include, but is not limited to a personal computer.

According to further features in preferred embodiments of the invention described below the input interface of the current invention further includes a scenario builder, a device builder, a virtual instructor builder, a terrain builder, an import export algorithm or a certification tool.

According to still further features in the described preferred embodiments the database further stores trainee data and the syllabus is based on the trainee data. The trainee data may include but is not limited to trainee performance data communicated to the processor by training equipment. Upon receiving the trainee performance data, the processor evaluates trainee performance and updates the database. The evaluation of performance including a replay of the exercise may be made available to the trainee or an administrative user. The trainee data may further include but is not limited to psychological data, an exercise previously completed by the trainee, time required by the trainee to complete previously completed exercises, previous experience of the trainee, and schedule information pertinent to the trainee.

According to still further features in the described preferred embodiments the input interface may serve but is not limited to serving to edit the topic, to edit the topic attribute, to enter information pertaining to a budget, to edit information pertaining to resource availability, or to edit information pertaining to scheduling.

According to still further features in the described preferred embodiments the output interface serves for presenting a training exercise, presenting a training session program, presenting orders for a required resource, reporting progress, reporting budget information, or for reporting schedule information.

According to still further features in the described preferred embodiments the syllabus includes a briefing to the trainee. The briefing informs the trainee of particular points in a mission requiring trainee attention.

According to still further features in the described preferred embodiments the syllabus includes a crew exercise. The crew exercise includes a plurality of trainees. The trainees may conduct the crew exercise remotely using output interfaces communicating via a network.

According to still further features in the described preferred embodiments the syllabus includes a mission program. The input interfaces, plurality of output interfaces and network serve to coordinate the mission.

According to still further features in the described preferred embodiments the database may store but is not limited to storing a data library, a tutorial, a tip, a memo or a test. The memo may require reception verification by an intended recipient.

According to still further features in the described preferred embodiments the database may further includes information pertinent to the trainee.

According to still further features in the described preferred embodiments the processor may push data to an output interface at an appropriate time.

According to still further features in the described preferred embodiments the syllabus may include a program for a class including a plurality of trainees.

According to still further features in the described preferred embodiments the system may further include a communication network in communication with the processor and a communication device in communication with the communication network. The communication device may be used as the input interface or the output interface. The communication network may include but is not limited to the Internet, a cellular communication network, a telephone network, a computer network, a radio transmitter and receiver network or interconnected fax machines.

According to another embodiment of the current invention there is provided a method for generating a syllabus for a trainee. The method includes the steps of providing a database containing at least one topic and at least one topic attribute, generating the syllabus based on the topic and the topic attribute and outputting the syllabus.

The topic attribute may include but is not limited to a topic level, an order in which topics are to be covered, an exercise for training the topic, a prerequisite for performing the exercise, an estimated time to complete the exercise, a resource required for the exercise, a resource availability, a requisites for successful completion of the topic, and a requisite for successful completion of the exercise.

The step of providing the database may include but is not limited to editing the topic, editing the topic attribute, entering information pertaining to a budget, editing information pertaining to resource availability, or editing information pertaining to scheduling.

The step of providing the database may include but is not limited to entering data into a personal computer, entering data using formatted evaluations, entering data via an output channel of a training simulator, entering data via a medical database, entering data via a psychological database, entering data via a data collection device of a vehicle, entering data via a device measuring the performance of a vehicle, entering data via an automated test reader, entering data via a personal digital assistant, entering data via a recording device, entering data via a scanner, or an e-mail message.

The output may provided by but is not limited to being provided by one of the following interfaces a video viewer, a training simulator program, a training simulator control channel, voice instructions, a communication channels of a vehicle, control channels of a training vehicle, or a printer.

The step of outputting the syllabus may include but is not limited to presenting a training exercise, presenting a training session program, presenting orders for a required resource, reporting progress, reporting budget information, presenting a crew exercise, displaying on a video viewer, transmitting a training simulator program to a simulator control channel, giving voice instructions, transmitting to a communication channels of a vehicle, transmitting to a control channels of a training vehicle, or a printing information or reporting schedule information.

According to further features in the described preferred embodiments the method further includes the steps of inputting trainee data and updating the syllabus based on the trainee data. The trainee data may include but is not limited to trainee progress communicated to the database by training equipment, psychological data, an exercise previously completed by the trainee, time required by the trainee to complete the already completed exercise, previous experience of the trainee, or schedule information pertinent to the trainee.

According to still further features in the described preferred embodiments the syllabus may include a program for a class. The class includes a plurality of trainees.

According to still further features in the described preferred embodiments the syllabus may contain a crew exercise. The crew exercise is performed by a plurality of trainees using a plurality of input interfaces. The input interfaces may be remote and interconnected by a network.

According to still further features in the described preferred embodiments the method includes the step of providing information pertinent to the syllabus. The information is for the use of the trainee.

According to still further features in the described preferred embodiments the syllabus is generated by a personal computer.

According to still further features in the described preferred embodiments the syllabus may include a flight training exercise.

According to still further features in the described preferred embodiments the method further includes the steps of providing a communication network in communication with the processor and providing communication devices in communication with the communication network. The communication devices may serve to input the trainee data, to input topic data, to input attribute data or to output the syllabus. The communication network may include but is not limited to the Internet, a cellular communication network, a telephone network, a computer network, a radio transmitter and receiver network or interconnected fax machines.

According to yet another embodiment of the current invention there is provided a method of adaptive real time triangulation for progressive meshing of a domain based on a geometrical data set. The method includes the steps of generating an optimal unstructured map based on the geometrical data; storing the optimal unstructured map and constructing a polygon mesh in a section of the domain at a required level of detail. The polygon mesh is based on the optimal unstructured map.

According to still further features in the described preferred embodiments the method further includes the step of modifying a location in the polygon mesh to meet a required level of detail.

According to still further features in the described preferred embodiments the steps of generating a optimal unstructured mesh, storing the optimal unstructured mesh and constructing the preliminary polygon mesh are performed off-line and the step of modifying a location in the polygon mesh to meet a required level of detail is performed repeatedly on-line according to need.

According to still further features in the described preferred embodiments the step of modifying a location in the polygon mesh may include but is not limited to splitting a polygon and reducing a plurality of polygons. When splitting a polygon, assigning a height to a new vertex may include but is not limited to kridging from known heights in the optimum unstructured map, interpolation of heights in the optimum unstructured map, interpolation of heights in the polygon mesh, hierarchical subdivision and conditional random simulation.

According to still further features in the described preferred embodiments the splitting and the reduction of polygons is by the Rottger-Hiedrich algorithm.

According to still further features in the described preferred embodiments the geometric data is ground level data.

According to still further features in the described preferred embodiments the geometric data is digitized from a graphic image.

According to still further features in the described preferred embodiments the method further includes the step of rendering an image.

According to still further features in the described preferred embodiments the image is for use by a flight simulator.

According to still further features in the described preferred embodiments the step of generating an optimal unstructured map includes the sub-step of fitting a set of best-fit curves to the geometrical data.

According to still further features in the described preferred embodiments the step of generating an optimal unstructured map includes the sub-step of fitting a set of best-fit curves to the geometrical data and the best-fit curves are a set of splines.

According to still further features in the described preferred embodiments the step of generating an optimal unstructured map includes the sub-step of fitting a set of best-fit curves to the geometrical data. Furthermore, generating the unstructured map includes the sub-step of creating a set of control points from the set of best-fit curves.

According to still further features in the described preferred embodiments the step of generating an optimal unstructured map includes the sub-step of fitting a set of best-fit Bezier splines. Furthermore the generating an optimum unstructured map includes the step of choosing control points correspond to the Bezier splines.

According to still further features in the described preferred embodiments the step of generating an optimal unstructured map includes the sub-steps of breaking the domain into zones and generating an optimal unstructured map in at least one of the zones.

According to still further features in the described preferred embodiments the zones are divided such that each zone has a consistent variance structure.

According to still further features in the described preferred embodiments the step of generating an optimum unstructured map includes the sub-step of sampling the geometrical data. The unstructured map is generated from the sample of the geometric data.

According to still further features in the described preferred embodiments the size of the sample of the geometric data is chosen based on scale of variance of the geometrical data. For example, the size of the sample may be 20 points for every unit area equal to the squared integral scale of the variance of the height data.

According to still further features in the described preferred embodiments the step of generating an optimal unstructured map includes the sub-step of analyzing the scale of variance of the geometrical data.

According to still further features in the described preferred embodiments the analysis of scale of variance is may include but is not limited to a Fourier analysis and spatial-statistical analysis.

According to still further features in the described preferred embodiments the description of the variance structure may include but is not limited to one characteristic selected from the list including a spectrum, a variogram, a covariogram, a fractal, or indicator statistics.

According to still further features in the described preferred embodiments conditional random simulation may be used for but is not limited to simulate data in a location where the geometrical data is inadequate for the generation of the optimal unstructured map, to fill in data in a location where the optimal unstructured map is insufficient for the construction of the polygon mesh and to fill in data when modifying the polygon mesh in a location where the optimal unstructured map and the polygon mesh are insufficient for the required level of detail.

According to still further features in the described preferred embodiments the constructing a polygon mesh includes the step of triangulation.

According to still further features in the described preferred embodiments the triangulation is Delaunay triangulation.

According to still further features in the described preferred embodiments constructing a polygon mesh includes the sub-step of simplifying at least one map selected from the group consisting of the optimal unstructured map and the polygon mesh.

According to yet another embodiment of the current invention there is provided a method of adaptive real time triangulation for progressive meshing of a domain based on a geometrical data set. The method includes the steps of storing a geometric map of the domain and constructing a polygon mesh in a section of the domain at a required level of detail based on the geometric map. The step of constructing a polygon mesh includes the sub-steps of dividing the domain into a plurality of sub-domains and constructing a plurality of polygon sub-meshes. Each polygon sub-mesh is in one of the sub-domains. Each polygon sub-mesh is based on the geometric map. The step of constructing a polygon mesh further includes the sub-step of joining a first sub-mesh to a second sub-mesh of the plurality of sub-meshes. Joining is performed at a common boundary between the first sub-mesh and the second sub-mesh.

According to further features in the described preferred embodiments the sub-step of joining is by stitching.

According to still further features in the described preferred embodiments the geometric map is an optimal unstructured map.

According to still further features in the described preferred embodiments the sub-step of dividing the domain into sub-domains may be accomplished by employing at least one attribute selected from the group consisting of variance and required level of detail.

According to yet another embodiment of the current invention there is provided a system to progressively mesh a domain using adaptive real time triangulation. The system includes a processor. The processor is designed and configured for generating an optimal unstructured map of the domain based on geometric data. The processor is also configured and designed for constructing a polygon mesh of a portion of the domain at a required level of detail based on the optimal unstructured map and for modifying the polygon mesh to meet a new required level of detail. The system further includes an input interface capable of communicating with the processor. The input interface is designed and configured for inputting the geometric data. The system further includes a database capable of communicating with the processor. The database is designed and configured for storing the optimal unstructured map and the polygon mesh. The system further includes an output interface capable of communicating with the processor. The output interface is designed and configured for outputting the polygon mesh.

According to further features in the described preferred embodiments the processor is further designed and configured for breaking the domain into a plurality of sub-domains, generating a sub-mesh in each sub-domain and joining the sub-meshes.

According to still further features in the described preferred embodiments the processor is further designed and configured to analyze variance of the geometric data.

According to still further features in the described preferred embodiments the processor is further designed and configured to simplify the optimal unstructured map or the polygon mesh.

According to still further features in the described preferred embodiments the processor is further designed and configured to select sample of points from the geometric data.

According to still further features in the described preferred embodiments the processor is further designed and configured to fill in the geometrical data with simulated data at a location in the domain by conditional random simulation.

According to still further features in the described preferred embodiments the input interface includes a digitizer to manufacture the geometric data from a graphic image.

According to still further features in the described preferred embodiments the output interface is a flight simulator which uses the polygon mesh to render an image.

The current invention analyzes trainee performance to determine which topics were easily understood and which topics require further training. Based on the trainee's performance, a customized personal syllabus is created. Time and attention for any given topic are adjusted to student needs, thereby extending or reducing the time per topic and optimizing the individual's learning pace.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic representation of a system for generating a dynamic training syllabus according to the present invention;

FIG. 2 is a flow diagram of a method for generating a dynamic training syllabus according to the present invention;

FIG. 3 is a schematic representation of the database and initial, revised, and final training syllabi of preferred embodiment 2.

FIG. 4 is a schematic representation of a system for generating a syllabus for an aviation group.

FIG. 5 is a schematic overview of a method of producing an optimal unstructured map and preliminary triangulated mesh according to the current invention;

FIG. 6 is a schematic view of triangulation of sub-domains;

FIG. 7 is a flow chart illustration of a method for adaptive triangulation;

FIG. 8 is a flow chart illustration of a dynamic method for polygon mesh modification;

FIG. 9a is an illustration of a polygon mesh;

FIG. 9b is an illustration of increasing LOD in a polygon mesh by vertex addition and interpolation;

FIG. 10 is a flow chart illustration of a method of joining sub-meshes;

FIG. 11a is a an illustration of triangulation two of rectangular sub-meshes;

FIG. 11b is an illustration of two improperly joined rectangular sub-meshes;

FIG. 11c is an illustration of joining two rectangular sub-meshes by vertex omission;

FIG. 11d is an illustration of joining two rectangular sub-meshes by vertex addition;

FIG. 12a illustrates a quadtree structure used for Rottger-Hiedrich triangulation;

FIG. 12b illustrates the triangulation of a Rottger-Hiedrich quadtree structure;

FIG. 13 illustrates reduction of LOD in a Rottger-Hiedrich quadtree structure;

FIG. 14 illustrates a Rottger-Hiedrich quadtree structure that cannot be joined by vertex elimination;

FIG. 15a is a three-dimensional wire-frame illustration of a mesh without cracks;

FIG. 15b is a three-dimensional wire-frame illustration of a mesh with cracks;

FIG. 16 illustrates a system for progressive meshing according to the present invention.

### DESCRIPTION OF THE PREFERRED EMBODIMENTS

The present invention is of a dynamic professional syllabus which can be used to make training programs more efficient. Specifically, the present invention can be used to conserve training resources by monitoring trainee progress.

The principles and operation of a system and method for a dynamic professional syllabus according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

For purposes of this specification and the accompanying claims, the phrase indicator statistics refers to numerical data indicating the location of characteristic forms in a domain.

For purposes of this specification and the accompanying claims, the phrase outputting a syllabus includes the reporting of data from the syllabus or presenting a mission from the syllabus to a trainee or to a user.

For purposes of this specification and the accompanying claims, the term map refers to a data structure defining a value of a characteristic at a plurality of locations in a domain.

For purposes of this specification and the accompanying claims, the term mesh refers to a data structure defining a value of a characteristic in continuous space in a geometric domain.

For purposes of this specification and the accompanying claims, the phrase polygon mesh refers to a data structure defining a value of a characteristic on set of polygons in a geometrical domain.

For purposes of this specification and the accompanying claims, the term trainee refers to any user of receiver of information.

For purposes of this specification and the accompanying claims, the terms geo-statistics and spatial-statistics.

For purposes of this specification and the accompanying claims, the term mission refers to an assignment to a person or a group of people and the assignment may be for the sake of training or have an intrinsic motivation.

For the purposes of this specification and the accompanying claims, the phrase generate a syllabus may include but is not limited to scheduling a mission, scheduling a class, revising a schedule, updating data in an existing syllabus, sending messages to involved personnel, and reserving equipment.

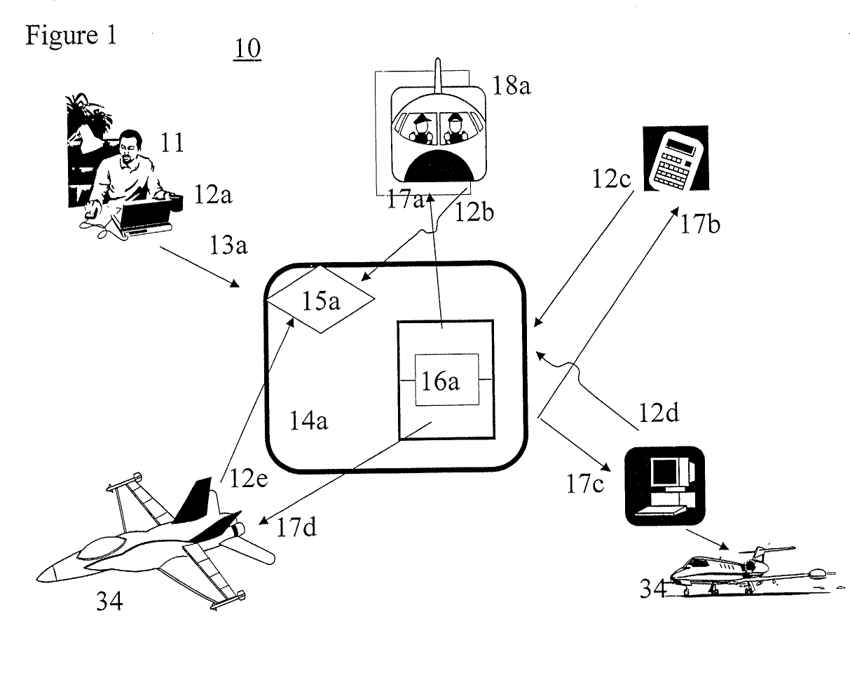

Referring now to the drawings, FIG. 1 illustrates a first preferred embodiment which is a system for a dynamic training syllabus, which is referred to hereinunder as system 10.

System 10 includes: a database 14a for storing training topics and topic attributes. System 10 also includes a processor 15a which generates a training syllabus 16a based on the training topics and training topic attributes. The database and processor may be, for example, the storage and processing components of a personal computer. System 10 also includes input interfaces, for example 12a, 12b, 12c, 12d, and 12e communicating with processor 15a and, output interfaces, for example 17a, 17b, 17c, 17d, and 17e communicating with processor 15a.

Training coordinator 11 inputs data including training topics and topic attributes into input interface 12a, which may be, for example, a personal computer. The data is relayed over a local area network 13a to via processor 15a to database 14a. Database 14a is in communication with processor 15a. Processor 15a generates a training syllabus 16a. Syllabus 16a is stored in database 14a. Processor 15a outputs a first program from stored syllabus 16a for the first training session to a first output interface 17a. For example, output interface 17a is the input channel of a flight simulator 18a. The first program contains a formatted simulator control program communicated through the simulator control channel of output interface 17a. The first program also contains instructions for the trainee during the simulated flight. The instructions are presented during the training exercise on the video screen of simulator 18a.

It is understood that exercises supplied by training coordinator 11 may include audio visual materials which can be scanned into input interface 12a or input through a digital video recorder. Physical materials such as audio and videotapes, charts and drawings may also be made available to trainees. The store room for such materials can be considered part of database 14a and the materials can be communicated to database 14a by any convenient means, for example fax or mail.

Database 14a further stores trainee progress data. Thus, the output channel of flight simulator 18a is also a second example of an input interface 12b communicating trainee performance data to processor 15a. Processor 15a evaluates the trainee performance data according to performance requisites stored in database 14a and updates database 14a by adding a current evaluation of trainee performance. Input interfaces for inputting trainee performance include but are not limited to a formatted evaluation such as a multiple-choice test graded by an automated test reader, a data collection device of a vehicle such as a flight recorder, a device measuring performance of a vehicle such as flight controller radar, a voice communication device such as an aircraft radio, a recording device such as a video camera.

Processor 15a receives data pertaining to the availability of an instructor from input interface 12c which is, for example, the instructor's personal data assistant (PDA). PDA 12c can also be used to edit scheduling data, the edited data being uploading to database 14a at a convenient time. Processor 15a also receives resource availability data from input interface 12d which is the workstation of a resource provider. Input interface 12d is also used to input information pertaining to equipment cost and a budget. When there are changes in costs, input interface 12d is used to edit budget information. Processor 15a uses the training topic data, the trainee data, and the scheduling data to update training syllabus 16a.

Processor 15a subsequently communicates an updated training schedule from database 14a to output interface 17b, which is, for example, instructor PDA 12c. PDA 12c reports scheduling information to the instructor. Processor 15a also communicates an updated training schedule from database 14a to output interface 17c which is, for example, resource provider workstation 12d. Resource provider workstation 12d further presents orders for resources required for the training session to a resource provider. For example, in this preferred embodiment, the resources include training vehicle 34, an aircraft for use in a training flight. If a piece of equipment for example vehicle 34 is out of service, the resource provider uses input interface 12d to edit information pertaining to resource availability to reflect the change in the status of vehicle 34.

It is understood that communication with PDA 12c and workstation 12d is by any convenient communication network. For example, a telephone or automated e-mail system can be used to contact an instructor who manually extracts data from PDA 12c and sends a return message to database 14a or alternatively PDA 12c may be capable of direct cellular communication (for example the Nokia Communicator^{T} and the like) in which case database 14a directly communicates with PDA 12c over the cellular network automatically receiving schedule information and reserving dates for training sessions. Communication with workstation 12d is, for example, over the Internet. It is also understood that workstation 12d can supply resource cost information to database 14a. The cost information can be used, for example, by an accountant for budgetary calculations.

Further examples of networks include but are not limited to a cellular communication network, a telephone network, a computer network, a radio transmitter and receiver network and interconnected fax machines.

During the training flight, processor 15a presents an updated second training session training program from database 14a via voice instructions over output interface 17d which is, for example, the radio receiver of training vehicle 34 to an instructor on board training vehicle 34. The radio transmitter of training vehicle 34 also acts as a second input interface 12e and communicates trainee performance data to database 14a. Further trainee performance data may be reported to database 14a from external measurements of vehicle performance supplied for example by control tower radar. It is understood that in this way, processor 15a may adjust second session training program during the session. Such an adjustment saves valuable time and resources when unforeseen circumstances interfere with execution of the original training program.

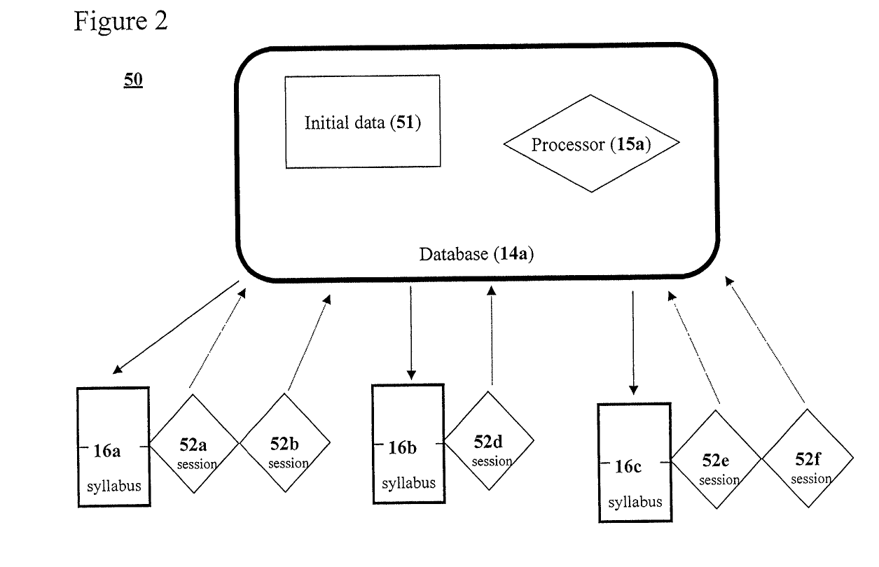

FIG. 2 illustrates a second preferred embodiment hereunder referred to as method 50, which is a method for a dynamic training syllabus. In the first step there is supplied database 14a including initial data 51 and processor 15a. Initial data 51 includes data on topics to be covered, attributes of the topics and may also include information on trainees.

For example, initial data 51 for a pilot training course may include the following topics: (A) avoiding dynamic stall (B) ascending in an aircraft. The syllabus also specifies that the order of completing the topics. A trainee must be first learn to avoid stall and then ascending in an aircraft. Each topic includes attributes, for example: I) Exercises (A) pertaining to avoiding dynamic stall (i) class in flight theory—conditions that cause stall (ii) simulation of stall 1 (iii) simulation of stall 2 (iv) flight training avoiding stall—estimated time to complete exercise 2 hours (v) flight training recovering from stall—estimated time to complete exercise 3 hours (B) exercises pertaining to ascending in an aircraft (i) class in aircraft control (ii) simulated ascent (iii) flight training ascent—estimated time to complete exercise 3 hours; (II) Prerequisites: flight training of stall recovery requires flight training of stall avoidance; flight training of ascent requires simulator training of stall (III) Requisites for completion of topics (A) avoidance of stall—successful recovery from stall in real flight (B) ascent in an aircraft—successful ascent in real flight; (IIII) Trainee data (trainee [A]) previous training in aeronautical engineering, previously completed ascent simulator exercise, required time to complete ascent simulator exercise was 2 hours; (trainee [B]) psychological examination revealed that may be panic prone (trainee [C]) physiological data reveal that is left handed.

Based on initial data 51 an initial training syllabus 16a is generated and output to an instructor (syllabus output is represented by the solid arrow). In the pilot training example, syllabus 16a includes a program for a first training session 52a (FIG. 2), which is, for example, a class in aeronautical theory. At the end of training session 52a trainees complete an exam using a computer graded test form output by a printer (not shown). A test reader grades The test form and communicates the results into via processor 15a to database 14a (trainee data input is represented by the dotted arrow). Processor 15a compares test results to the exercise completion requisites in database 14a and passes the trainees to a second training session 52b (FIG. 2) which is, for example, a flight simulation session to be attended by all trainees. If test results were poor, training syllabus 16 would be updated by processor 15a to include further classes containing exercises on topics that were incompletely mastered. A training coordinator 11 may also use an input interface 12a to edit topics or topic attributes. For example, if training supervisor feels trainees [A], [B] and [C] are unprepared making stall exercises are too dangerous then training supervisor edits the attributes of the topic (A) avoiding dynamic stall and adds more prerequisites. Trainings supervisor 11 may also use input interface 12a to edit a training topic. For example, training supervisor 11 may change the topic from “(A) avoiding dynamic stall” to “(A) theory of dynamic stall” removing the in flight stall exercise.

Based on psychological data on trainee [B], syllabus 16a includes a program 79c for a second simulation session for trainee [B]. In this example, trainee [B] excels in flight simulation 52b and based on the results of training session 52b input into database 14a, processor 15a outputs a revised training syllabus 16b which does not include second simulator session program 79c.

Trainee performance is input to database 14a after flight training in third training session 52d (FIG. 2). For example, trainee [A] took longer than scheduled to complete flight training exercise i. Based on the trainee performance data, final training syllabus 16c includes extra time for flight training for trainee [A] in fourth and fifth training session programs 79e, and 79f respectively. Programs 79e and 79f are, for example, further flight training session programs. During training sessions 52e (FIG. 2) and 52f (FIG. 2), trainee performance is reported to database 14a. Because in this example, trainee performance is acceptable, final training syllabus 16c is the final training syllabus.

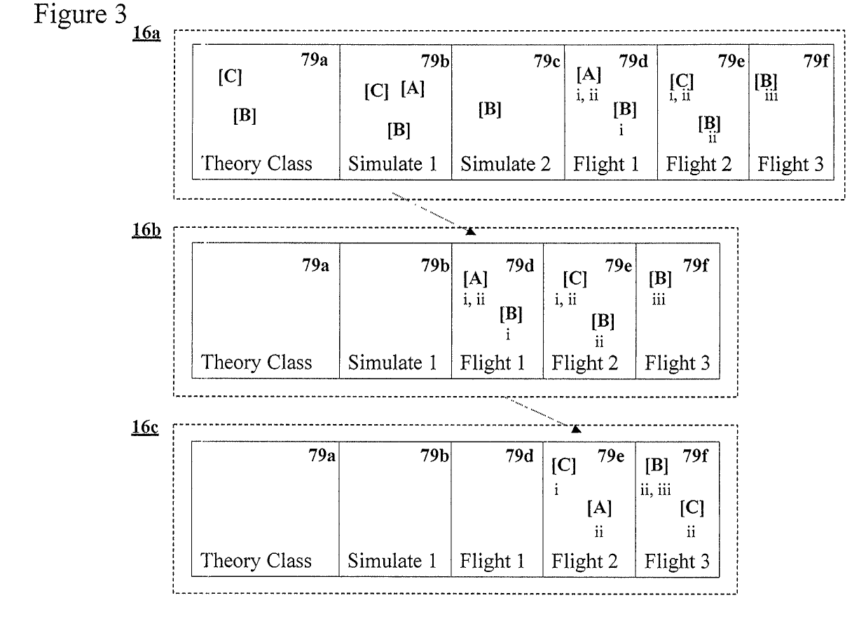

The initial syllabus 16a, revised syllabus 16b and final syllabus 16c of the second preferred embodiment are shown in FIG. 3. Each syllabus contains session programs 79a, 79b, 79c, 79d, 79e, 79f. Each training program 79a, 79b, 79c, 79d, 79e, 79f is to be attended by at least one trainee represented by a letter in square brackets. Exercises to be completed by each trainee in the flight training programs 79d, 79e, 79f are shown by small Roman numerals below the trainee letter.

Class program 79a may include printed material, for example, a class schedule, exercises and test questions. Program 79a may also include audiovisual materials for use of the instructor. Based on data pertaining to previous experience, trainee [A] is not required to attend class 52a (FIG. 2) and is not included in program 79a.

Program 79b is a flight simulator session to be attended by all trainees.

Based on psychological data, trainee [B] is scheduled to attend an extra simulated flight training session in program 79b. In this example, trainee [B] performs exceptionally well in second training session 52b (FIG. 2). Based on trainee performance data input (shown as a dotted arrow) into database 14a (FIG. 2) from training session 52b a revised syllabus 16b is generated and output. Revised syllabus 16b does not contain second simulator session program 79c. Therefore according to revised syllabus 16b, flight training program 79d comes directly after simulator training program 79b.

According to revised syllabus 16b, trainee [A] is to complete flight training exercises i and ii in flight training session 52d (FIG. 2) as is seen in training program 79c. In the example, trainee [A] completed only flight training exercise i in training session 52d. Therefore, after input of performance data from session 52d, final syllabus 16c transfers flight time from trainee [C] in training program 79e to trainee [A]. Training program 79f is lengthened to give more time for trainee [C] making up for the training time lost by [C] is program 79d.

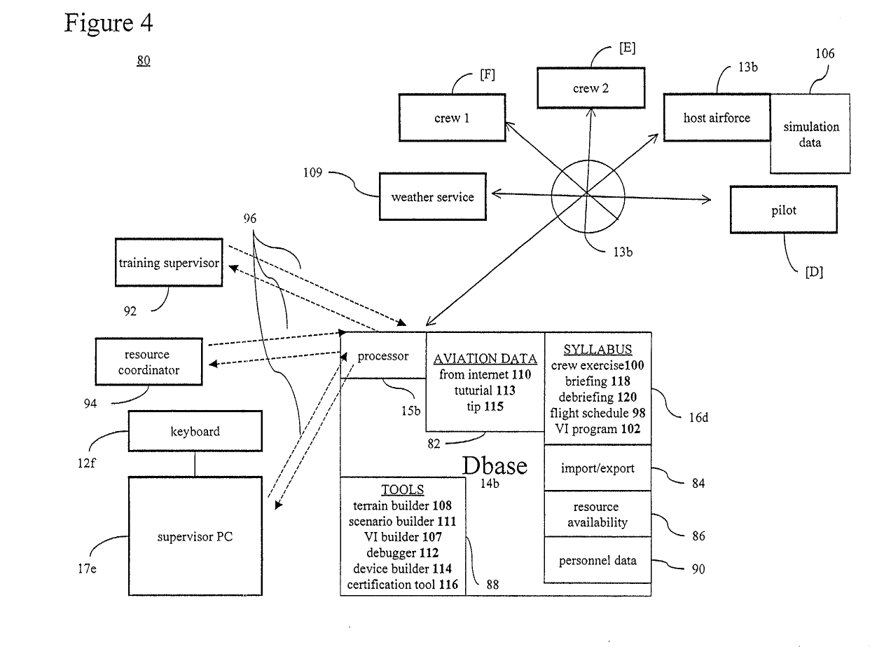

FIG. 4 illustrates a third preferred embodiment, which is a system for a dynamic training syllabus, which is referred to hereinunder as system 80.

In system 80 there is a processor 15b and a database 14b. Processor 15b is in communication with network 13b, which is the Internet. Database 14b includes a library of aviation data 82 an import export algorithm 84, resource availability data 86. tools algorithms 88, and a syllabus 16d. In system 80, syllabus 16b is a syllabus for a flight mission. The mission of system 80 is to bring medical equipment to a flooded region in a Spanish speaking country on a outbound leg of the mission and to bring injured people to medical treatment on the return leg of the mission.

A supervisory user uses, for example, a desktop personal computer (PC) as an output interface 17e and a keyboard as an input interface 12f. Output interface 17e is connected to processor 15b through a high-speed intranet 96. The supervisor first generates a new mission syllabus 16d, which will store data and scheduling for the new mission. Having received a request for the mission the supervisory user must first identify trainees who will be crewmembers. A flight crew must include crewmembers with experience flying large cargo aircraft on short runways, have medical skills, have current inoculations against hepatitis, and be able to communicate in Spanish. To find crewmembers, the supervisory user accesses database 14b using input interface 12f and requests that processor 15b search personnel data 90 for trainees having the proper qualifications. For example personnel data 90 includes a medical database supplied and updated with permission from employee by personal physicians. The medical database includes an inoculation status for each employee. Because database 14b does not contain data on medical skills, the supervisor uses processor 15b to send a memo to all flight personnel. In order to keep track of potential crewmembers that have yet to be reached, the memo requires an acknowledgement with a digital signature from each recipient. The memo requests that employees having medical training send a list of medical qualifications.

The supervisory user identifies three people including a first trainee [D] who is a pilot, a second trainee [E] who is a navigator and also knowledgeable in first aid, and a third trainee [F] who is a copilot and Spanish speaker. The supervisory user sends a message to a training supervisor 92 requesting that training supervisor 92 arrange a crew exercise covering short foul weather landing and takeoff using local data from the mission destination. Training supervisor is also to provide information pertinent to the syllabus such as health conditions in the destination country and visa requirements. Training supervisor 92 is to add the pertinent information to database 14b.

Trainer 92 adds a crew exercise 100 to a mission syllabus 16d. Pilot, trainee [D], will train on a flight simulator while crew members [E] and [F] will participate from their homes using, for example, personal computers as communication devices (PCs serve as both input interfaces 12 and output interfaces 17) communicating over network 13b. Crew exercise 100 includes trainees [D], [E], and [F] and is designed to give trainees [D], [E], and [F] experience working together under conditions analogous to the conditions of the planned mission. Therefore crew exercise is synchronous and simulator data includes sound recorded over a microphone (not shown), terrain images (not shown), cockpit instrumentation and readings (not shown) and messages from a virtual instructor (VI) 102. The simulator data are output to trainee pilot [D] and simultaneously relayed to trainee crew [E] and [F] over network 13b.

Training supervisor 92 must build exercise 100. The first step is to develop topics and topic attributes to be covered. Training supervisor first outlines topics to be covered and attributes of the topics. Training supervisor 92 must also develop a model of local terrain. To develop the terrain model, trainer 92 uses network 13b to e-mail an air force official 104 from the host country requesting local terrain data 106 for use in exercise 100. In reply, air force official 104 sends data 106 as an e-mail attachment to trainer 92. Data 106 needs to be adapted to an available simulator. Therefore data 106 is first converted using import/export algorithm 84, which contains programs for processor 15b facilitating transfer of data between various simulator formats. A terrain builder tool 108 facilitates, through interactive menus, the development of a locally accurate simulation model. Builder 108 is an algorithm executable by processor 15b. Builder 108 outputs a simulator instruction code to simulate local conditions based upon interactive menu driven choices. For example, a weather tool (not shown) allows adjust the lighting, sound, and instrument readings in order to simulate rain, lighting and high winds. The weather tool also adjusts appropriate parameters such as the ground hardness in response to specified rates for rainfall. Lightening may be added at specific times in the simulation, as specific points in the simulation (for example when the aircraft reaches a certain altitude in final landing decent) or at random times according to a random distribution function specified by trainer 92. Terrain builder 108 also menus for adding a structure (for example a building) from terrain data 106.

Along with terrain data 106 in the proper format exercise 100 contains a VI 102. VI building tool 107 is a computer algorithm that facilitates the programming of a virtual instructor. The VI, gives instructions to trainees during a training session in response to trainee actions. Specifically, the destination runway of the mission is a grassy field. The grassy field is softer than temporary runways of dessert stone in the home country of pilot [D]. Therefore, one instruction that trainer 92 programs into VI 102 is that if pilot [D] approaches the runway with a steep decent, VI 102 informs pilot [D] that this runway is of soft wet dirt and must be approached more carefully. VI builder 107 can also be used to build a virtual peer to the trainee. For example, VI builder 107 can build a virtual crewmember for simulations that do not include the entire crew learning synchronously. Thus, a crew exercise can be made non-synchronous by recording the reactions of one crewmember during a simulation and designing a virtual peer to react in a similar fashion. Information from a psychological database (not shown) included in personnel data is also used to program the reactions of virtual crewmembers. The remaining crewmembers then perform simulations with the virtual peer. Similarly, for combat pilots, the virtual peer would be an enemy pilot.

Builder tools 88 include but are not limited to VI builder 107, terrain builder 108, a scenario builder 111, a device builder 114, a certification tool 116 and a debugger 112. Device builder 114 is an algorithm for an interactive tool to facilitate designing and modifying a virtual cockpit of a simulator to resemble real or proposed aircraft. Device builder 114 can also be used to design a virtual weapons having properties of known real weapons such as missiles for combat simulations. Certification tool 116 checks code to test if the code meets programming standards. Programming standards may be rules of programming etiquette for portable code, or programming standards may be requirements of particular target devices and processors. Debugger 112 monitors program progress during a simulation and outputs a log file that informs a user of the state of various virtual device and actor codes. Debugger 112 is useful for tracing coding errors that cause a simulator program to fail. Scenario builder 111, allows a trainer 92 to specify alternate scenarios for a missions. For example, in embodiment 80, trainer 92 uses scenario builder 111, to set up two scenarios. In the first scenario the flight arrives during a thunderstorm and in the second scenario the weather is good but the airstrip is crowded. Scenario builder 111 facilitates interactive building of scenario's that share some information (for instance terrain, aircraft characteristics) but have significant non-shared data. Writing two simulations as two scenarios saves storage space and run time (because processor 15b does not need to load and reload all the data of both scenarios separately into memory).

The supervisor also uses input interface 12f, output interface 17e, intranet 96 and database 14b to mark a transport aircraft as reserved in resource availability data 86. Processor 15b automatically pushes a message over intranet 96 informing a resource coordinator 94 of the change to resource availability data 86. Processor 15b also pushes a message to the supervisor reporting the cost of ordered equipment as budget information over output interface 17e. Resource coordinator 94 then adds to mission syllabus 16d a scheduled item 98 that will trigger on the morning of the mission and send a message over intranet 96 to ground personnel reminding them to prepare the aircraft. In this way processor 15b and database 14b coordinate data and messages. Thus processor 15d sends messages on the inter-net or intranet to remind users or trainees of data, missions, classes, changes in laws, changes in policy, upcoming exams, and periodically reminds pilots to review particular subjects. Processor 15d also reports progress and activities of trainees over output interface 17e to the supervisor. Processor 15d also collects information 110 relevant to trainees who are pilots from the Internet, for example changes in laws, changes in policy, upcoming exams, weather forecasts 109, and airport conditions. After collecting information 110, processor 15d sorts and stores information 110. When information 110 fits a predetermined criterion, a message or information 110 itself is pushed to the trainee or user in an e-mail message or an internal memo. Information may be pushed to a user in an immediate on line message. For example a reminder is sent to an instructor and trainees immediately before scheduled class. A message may be sent as an e-mail message. For example, when there are changes in air-routes, an e-mail is sent to concerned pilots with an attached map. Information may be collected and sent as a bundle at a predetermined time set aside for review of new information. For example processor may collect industry reports of new aircraft technology and forward the reports as a bundle to pilots every Friday morning.

Database 14b also contains tips 115 and tutorials 113. For example, a pilot may submit a tip 115 based on experiences at an individual airport. A supervisor may submit a tip or a tip may be automatically generated by a virtual instructor and targeted to the particular trainee when the trainee has consistent trouble with a certain skill. Pilot [D] after being informed of his new mission looks through tips database 115 to find any comments from pilots flying into unfinished airstrips in the region of the mission. Tutorials 113 are used brush up old skills or develop new skills. For example, pilot [D] has not flown the type cargo plane reserved for the current mission for a few years. Pilot [D] finds a tutorial 113 supplied by the plane manufacturer reminding pilots of the structure and placement of instruments, the load and speed limits of the aircraft and the recommended pre and post flight checks.

Database 14b also includes briefing 118 and debriefing 120 data. Briefing 118 informs trainee [D], [E], and [F] of particular points in an exercise or mission requiring trainee attention. Data in a briefing 118 is tailored to a given mission or exercise and also to a given trainee. Thus, for the cargo mission of this embodiment, training supervisor 92 sets up a briefing for crew exercise 100. The briefing data includes reminders of the difficulties to be expected in exercise 100 and notes on the crewmembers. Specifically, pilot [D] is reminded that on the return leg of the journey navigator [E] may be busy with patients being transported and therefore pilot [D] must remain aware of navigational problems. Similarly copilot [F] is reminded that pilot [D] has most of his experience under dessert conditions and should be reminded of potential problems related to wet conditions.

An evaluation of performance of a trainee in an exercise or on a mission is reported in a debriefing 120. Debriefing 120 information includes records from VI 102 as well as records of crew activities during a real or training mission. Thus, the debriefing data reminds pilot [D] of mistakes made during the training mission. Debriefing data 120 is sufficient to allow pilot [D] to replay the simulator flight, stopping or slowing the replay, and viewing the replay at different angles in order to understand the cause of problems and how problems can be avoided. Replay data may be stored on a videotape, then the output interfaces being, for example, a video viewer.

VI program 102, briefing 118, library information 82, reminders, and debriefing data 120 are made available to pilot [D] before during and after a real mission via an on board computer and on board communication equipment of the mission aircraft.

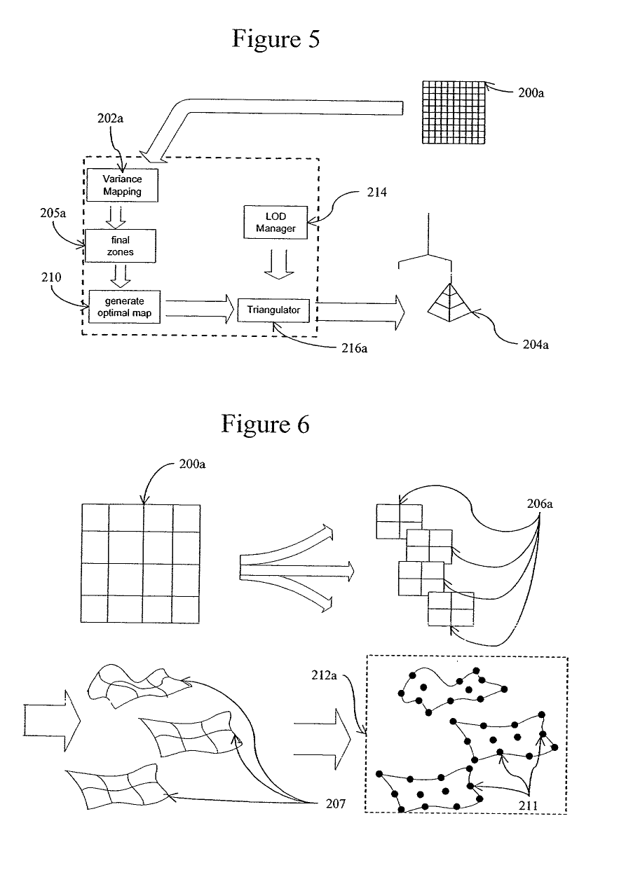

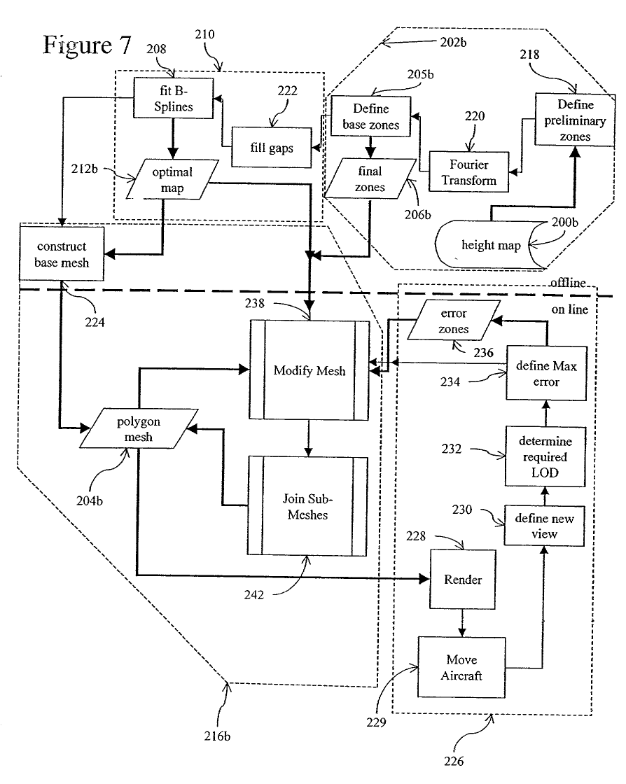

FIG. 5 is a schematic overview of a method for construction of a base polygon mesh 204a. Construction of a base polygon mesh 204a is accomplished offline prior to a flight simulation. Base polygon mesh 204a is a simple mesh containing only active vertices without the need for complicated hierarchal structures requiring graphical expertise. The geometrical input to the method is raw geometrical data 200a. Data 200a is a set of point elevation values generated by digitizing a graphical image for example a aerial photograph. Geometrical data 200a is not optimized. Therefore, there may be large numbers of unnecessary data points. A data point is unnecessary if the elevation of the point could be found to sufficient precision from by interpolation from nearby points. Geometrical data 200a may also be inadequate in some locations. Data is inadequate in a location if the correct height of the location cannot be determined to sufficient precision from the data. Therefore an optimal unstructured map 212a (FIG. 6) is generated and used to construct polygon mesh 204a.

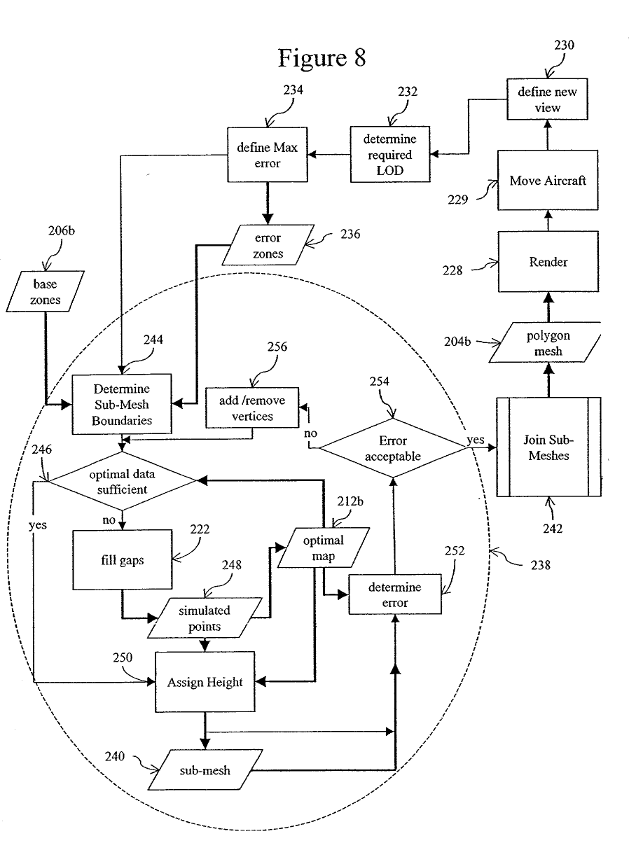

Before generating optimal unstructured map 212a, a domain of data 200a is variance-mapped 202a. The first step in variance mapping is breaking the domain into zones 206a (FIG. 6). First preliminary zones are divided 218 (FIG. 7) according to natural boundaries by visual inspection (for example separating hilly from flow terrain, separating a river valley from a plain). Variance mapping 202a may include but is not limited to Fourier analysis, spatial-statistics or fractal analysis. For example in spatial-statistical analysis, the set of possible lags between any two points is divided into bins. For example, for a square domain of 100 square kilometers, bins are chosen as 1-5 m, 5-10 m, 10-50 m, 50-200 m, 200-1000 m, 1000-5000 m. Variance may also be anisotropic and therefore, distance between two points (x₁, y₁, h₁) and (x₂, y₂, h₂) is defined as \sqrt{(x₁−x₂)²+([y₁−y₂]/λ)²} where λ represents the ratio of the integral scales in the y and x directions. For a data-pair (x₁, y₁, h₁) (x₂, Y₂, h₂) a variogram estimator (h₁−h₂)² is computed. In each zone, every pair of points is classified into a bin according to the lag distance between the points in the xy-plane. Various values of the anisotropy ratio λ are tested and the anisotropy ratio λ is optimized in each zone to minimize the variance of the variogram estimator within the bins. In each zone, a variogram is chosen by fitting the average height difference in the bins to a variogram model (for example a Guassian or an exponential variogram model). A covariogram may also be used for variance mapping.

According to the computed variograms and zone size, zones are further subdivided or joined. Specifically, the preliminary zones are broken into base zones 206a wherein each base zone 206a has a consistent variance structure. Specifically, a zone has a consistent variance structure if the coefficient of variation of variogram values in all bins is less than one. Preliminary zones having bins in which the variogram values have a coefficient of variation greater than one are subdivided. Within the zone pairs of points are classified as of high or low variogram value in the bin. The zone is divided into two or more zones wherein, the data pairs in each zone at a particular lag contain a consistent set of variogram values. For each new zone, a new analysis of variance is made. Preliminary zones are further subdivided when the size of the zone is greater than ten times the lag scale at which the variogram value is 6. For example a zone of size 1 Km in the x-direction and 1.4 Km in the y-direction has an anisotropy ratio λ=1.5 and a fit Guassian variogram of

$$v = 10 \{ 1 - exp ( \frac{- {( {x}_{1} - {x}_{2} )}^{2} - {[ ( {x}_{1} - {x}_{2} ) / λ ]}^{2}}{100} ) \} + 3$$

Thus the variogram is 6 at the lag of 60 m. Because of the effect of λ, the lag of 60 m occurs for an x-lag of 60 m or a y-lag of 90 m. Thus, in order that the domain be ten times the lag scale of a variogram value of 6, the 1×1.4 Km zone is further divided 205a into four smaller base zones 206a. Each base zone will be 0.5×0.7 Km (see FIG. 6). On the other hand, where there are two adjacent zones of consistent variance structure and each of the two zones are smaller than the determined base zone size, the two zones are combined into on large sub-domain. For example if two zones have a difference of less 30% in variogram values for all bins and have a difference of less than 30% in anisotropy ratios, then the zones are combined.

After variance mapping an optimal unstructured map 212a (FIG. 6) is generated 210. In each zone a set of best-fit Bezier Splines 207 (B-splines) are fit 208 to the geometrical data and a minimal set of points to reproduce the height map is defined as the control points 211 (FIG. 6) of B-splines 207. Optimal unstructured map 212a contains the height information of geometrical data 200a using a minimum storage. Unstructured optimum map 212a is stored and used for further refinements of polygon mesh 204a.

If 90% of the data pairs in a particular zone 206a are separated by lags of less than one integral scale of the variogram of the particular zone 206a, then B-splines 207 are fit 208 to a simplified geometric map including a small sample of the geometrical data in particular zone 206a. Specifically, where there is a cluster of data points having similar height within an area of radius one integral scale of lag, a small sample of the points is selected other data points being removed. Fitting 208 B-splines 207 to the smaller sample decreases the computer resources necessary to build a simulation.

LOD manager 214 defines a desired LOD for base polygon mesh 204a. Using the geometrical data from optimal unstructured map 212 and the LOD a triangulator 216a constructs base polygon mesh 204a by Delaunay triangulation.

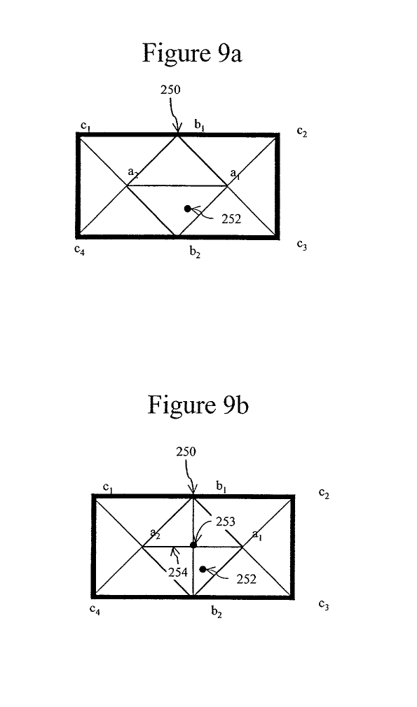

FIG. 7 is a detailed flow chart illustrating a method for adaptive triangulation. Note that in FIGS. 7 and 8, thin lines represent flow of the process while thick lines represent flow of data. The input to the method is height map 200b. In the first general step, analysis of variance 202b, a set of preliminary zones are defined 218. In each zone the spatial structure of the variance of height is analyzed 220 using a Fourier Transform. The bins of the spectrum of the Fourier Transform (wave-length) represent lag distance and the peaks heights of the spectrum represent the variance in height at the given lag. Based on the spectrum of the Fourier Transform, base geometric zones 206b are defined 205b.

After analysis of variance 220 and definition 205b of base zones 206b, an optimal unstructured map 212b is generated 210. In optimal unstructured map 212b, conditional simulation is used to fill in 222 areas with inadequate data. Specifically, at an area where there is inadequate data, an expected mean height and variance are calculated by kridging. Then a random number is generated from a distribution having the expected variance and mean zero. The height assigned to the point is a sum of the random number added and the expected mean.

Optimal unstructured map 212b is generated for each zone 206b by fitting 208 height map 200b to a set of B-splines 207 and storing the controls points 211 needed to generate the B-splines 207. Optimal unstructured map 212b requires one-fifth the storage space of raw height map 200b. The saving is not merely storage, but also processing time because in further steps of constructing a polygon mesh, the processor does not need to manipulate the huge data structures of raw height map 200b. Further reduction of data manipulation is achieved because new points for triangulation will be based on small-scale zones 206b and will not require manipulating the entire optimal unstructured map 212b.

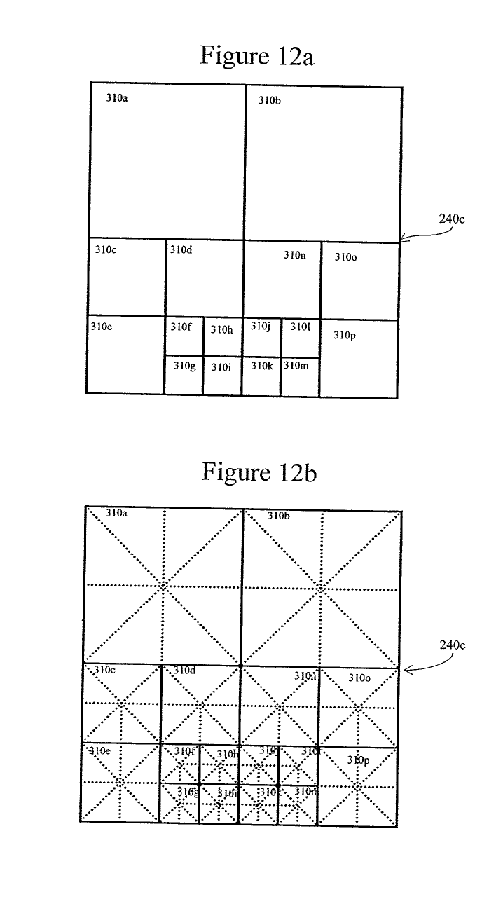

After generating optimal unstructured map 212b, a base polygon sub-mesh 204b is constructed 224 by triangulation 216b in each zone 206b. Base polygon sub-meshes 204b, unstructured optimal unstructured map 212b and zones 206b, are used on line in a flight simulation 226. Heights are assigned 250 to the vertices of each sub-mesh 204b by kridging based on known heights at neighboring locations in optimal unstructured map 212b. When a polygon 300h2 (FIG. 11d) is added (either during construction of sub-mesh 300h2, or during polygon reduction or splitting) to a sub-mesh 240b (FIG. 11d) a height error is computed and stored, the error being between the face of polygon 300h2 and points of defined height in optimal unstructured map 212b falling in the domain of the polygon 300h2.

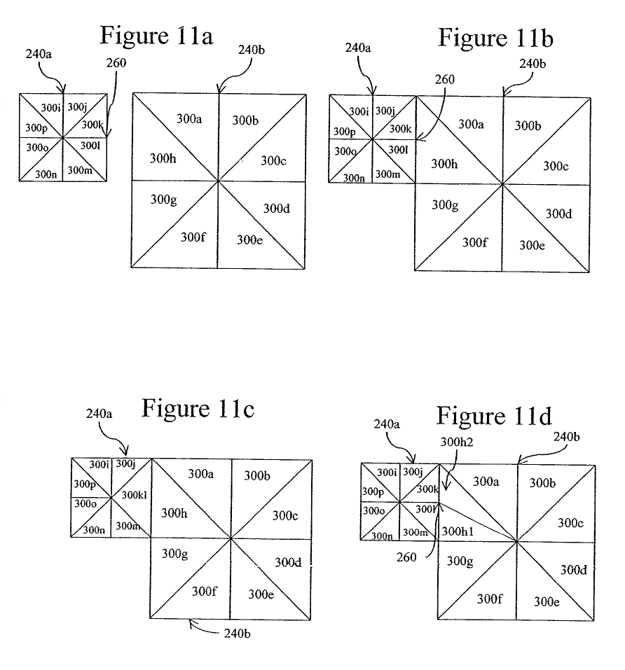

During flight simulation 226, polygon mesh 204b is used to render 228 an image for the simulator. According to movements 229 of a pilot and an aircraft, a new view is defined 230. The LOD required by the new view is determined 232. From the new LOD requirement, a maximum permissible height error is defined 234 everywhere and zones 236 of maximum permissible error are generated. Error zones 236 serve as input along with the optimal unstructured map 212b and polygon mesh 204b for polygon mesh modification 238. The detailed steps of mesh modification 238 are shown in the detailed flowchart of FIG. 8. Mesh modification 238 produces a set of sub-meshes 240 (FIG. 8) at the determined 232 required LOD. For smooth rendering, sub-meshes 240 must be joined 242. The details of a method for joining 242 sub-meshes 240 are shown in FIG. 10 and explained hereinbelow.

FIG. 8 is a detailed flow chart of a method for progressively modifying 238 a location in polygon mesh 204b. Based on maximum error zones 236 and base zones 206b (which are divided according to the variance of height) sub-mesh boundaries are defined 244. The step of determining sub-mesh boundaries is of great importance because modifying the entire polygon mesh 204b on line would be too slow for real time rendering and flight simulation. Therefore, sub-meshes 240 are determined and changes in LOD are carried out on line only a sub-mesh of sub-meshes 240. At times portions of the terrain will come into view or go out of view (for instance when a low flying aircraft passes a ridge). Included in redefinition of sub-mesh boundaries is the removal of invisible sub-meshes from active memory. A sub-mesh 240a (FIG. 11c) is removed only when sub-mesh 240a has been inactive for 100 time steps and when all sub-meshes 240b sharing a boundary with sub-mesh 240a are also invisible. When invisible sub-mesh 240a shares a boundary with visible sub-mesh 240b, sub-mesh 204a is stored in active memory for quick rendering in case sub-mesh 240a returns to active view.

In each error zone 236 there is a defined maximum error. The variance of height at each data point in the optimal unstructured map can be determined by kridging. If there are points in optimal unstructured map 212b where the standard deviation of the height is greater than the maximum permissible error 246, new points 248 are generated by conditional simulation 222. Points 248 are added to optimal unstructured map 212b. Whenever a point 248 is added to optimum map 212b an error between point 248 and a corresponding polygon face in polygon mesh 204b is computed and stored. When the optimal unstructured map 212b is sufficient, heights are assigned to new vertices of polygon sub-meshes 240 by kridging and new polygons are created in sub-meshes 240 as needed.

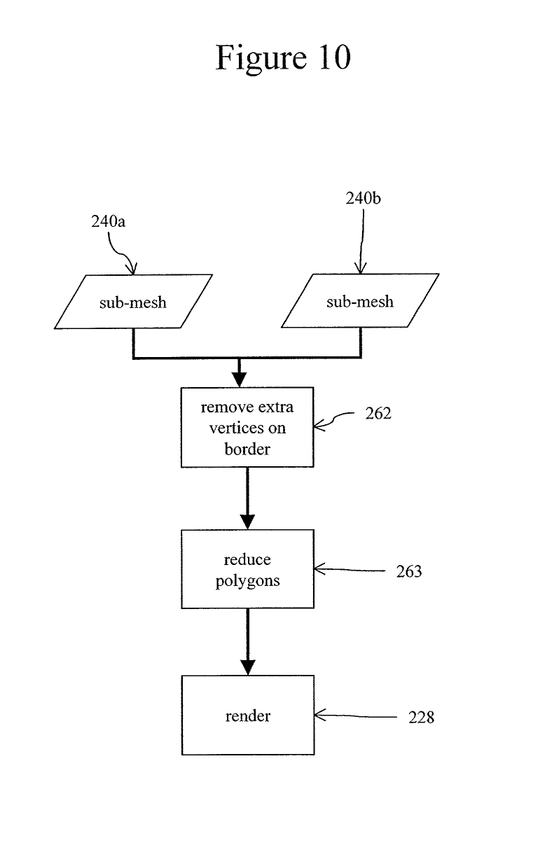

If 254 the maximum error in a sub-mesh from sub-meshes 240 is greater than the permissible error 234, then new vertices are added 256 to the sub-mesh where the error is beyond the permissible limit 234 and the process returns to testing whether the new sub-mesh is adequate. Adding 256 new vertices to a sub-mesh is illustrated in FIGS. 9a, and 9b. Joining 242 sub-meshes is illustrated in detail in the flowchart of FIG. 10 and in the illustrations of FIGS. 11a, 11b, 11c, 11d, 12a, 12b, 13, 14a, and 14b.

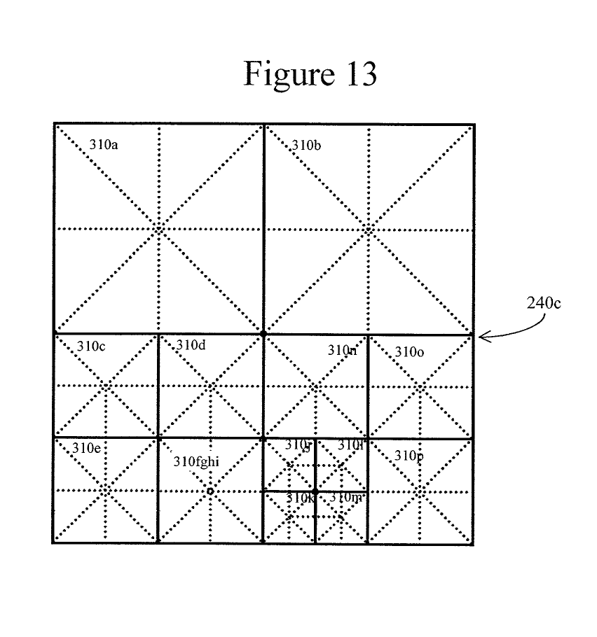

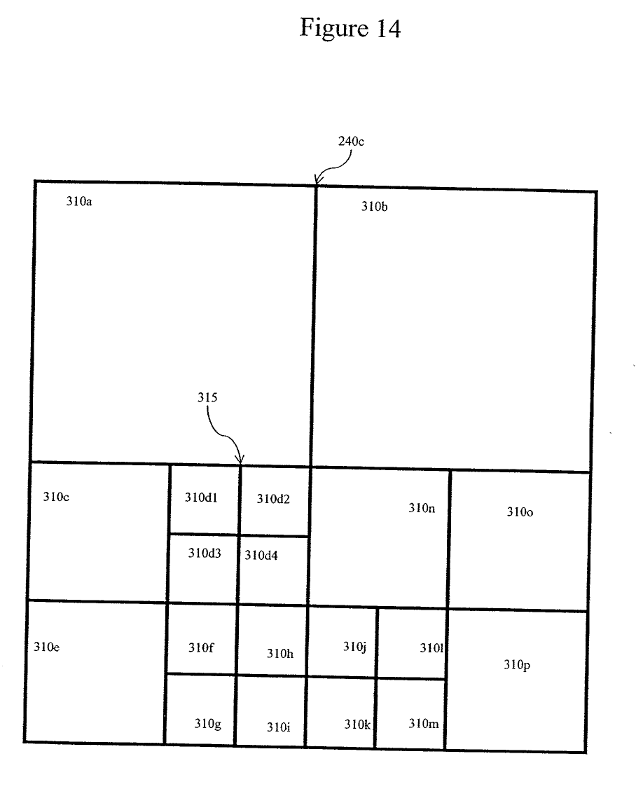

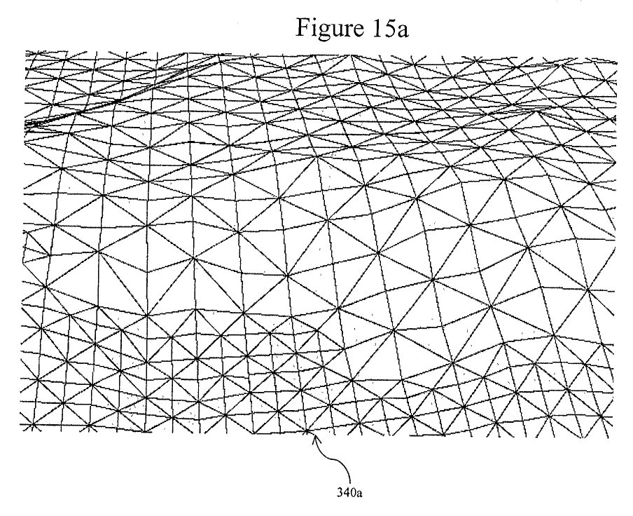

When a polygon sub-mesh 240c (FIG. 12a) exceeds the LOD requirements then vertices of sub-mesh 204c are removed and polygons reduced (FIG. 13). Specifically, if in a particular sub-mesh 240c, the error at 90% of points used for error testing have an error of less than 50% of the permissible error tolerance, then the particular sub-mesh 240c is simplified. In simplification, a vertex is removed from a sub-mesh. When a vertex is removed then polygons containing the vertex are reduced and new faces are based on the remaining vertices. Specifically, quadrilaterals 310f-i of FIG. 12 are reduced to quadrilateral 310fghi in FIG. 13. Reduction of polygons is not carried out where reduction will produce illegal structures (for example the illegal quadtree structure shown in FIG. 14 as explained hereinbelow).

If 254 the maximum error in all sub-meshes 240 is less than the permissible maximum error 234 and in no sub-mesh 240 is the error of 90% of the polygons less than 50% of the maximum error, then sub-meshes 240 are joined 242 to produce polygon mesh 204b for rendering 228.

FIGS. 9a-b illustrate a method of adding a new vertex 253 to a triangulated mesh using a modified butterfly interpolation algorithm to assign height to new vertex 253 based on old vertices a₁, a₂, b₁, b₂, c₁, c₂, C₃, and C₄. FIG. 9a illustrates a rectangle {c₁, c₂, c₃, c₄} 250 triangulated according to the Rottger-Hiedrich algorithm. The coordinates of each vertex a₁, a₂, b₁, b₂, c₁, c₂, c₃, and c₄ are defined by an ordered triplet (x, y, h) (0.5, 0.5, 1.2), (0.5, 1.5, 1.6), (1, 1, 2.1), (1, 0, 1.5), (0, 1, 1.3), (2, 1, 1.6) and (0, 0, 2) respectively. Any point inside rectangle 250 is found on the face of a triangle. The height of every point on each face is defined by three vertices surrounding the point. Specifically, point 252 is surrounded by vertices a₁, a₂, and b₂ and point 252 is located at (x, y)=(1.1, 0.25) therefore the height of point 252 is 1.49.

To increase detail in a triangulated region, a vertex is added at the center of a side of any existing triangle. Specifically in FIG. 9b in order to increase detail in the middle of rectangle 250, a vertex 253 is added at the center of side 254 (line segment {a₁, a₂}). The height of vertex 253 is assigned by interpolation according to the formula for the new point is h=(a₁+a₂)/4+(1/8+w)(b₁+b₂)+(c₁+c₂+c₃+c₄)(1/16−w/2) where w is an arbitrary weighing constant (whose value will usually be 1/8>w>−1/8). Specifically choosing the value of w as 1/8, the height of vertex 253 becomes (a₁+a₂+b₁+b₂)/4=1.575. After adding vertex 253, point 252 is surrounded by vertices a₁, b₂, and 253. Therefore the height of point 252 is 1.54.

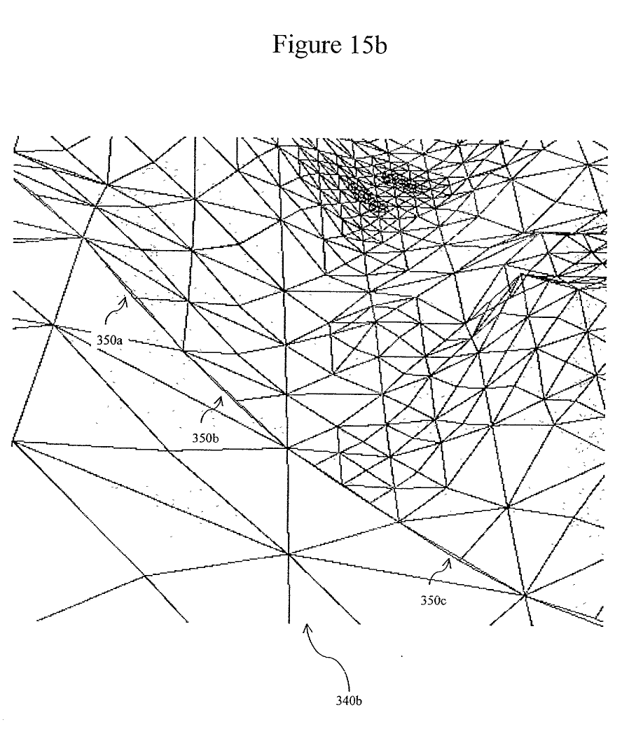

FIG. 10 is a flow chart illustrating a method of joining two sub-meshes 240a and 240b (sub-mesh 240a and sub-mesh 240b are shown separately in FIG. 11a and sub-mesh 240a and sub-mesh 240b are shown in their true joined position in FIG. 11b). Sub-mesh 240a shares a boundary with sub-mesh 240b where triangles 300k and 300l meet triangle 300h. On the shared boundary there is an extra vertex 260 in sub-mesh 240a for which there is no corresponding vertex in sub-mesh 240b, when the mesh is rendered, at the location of the extra vertex, a crack will form (see illustration of cracks 350a, 350b, and 350c FIG. 15b). The crack is removed 262 by removing vertex 260 (FIGS. 11a, 11b). Removing 262 vertex 260 requires reduction 263 of triangles 300k and 300l (FIG. 11b) producing triangle 300kl (FIG. 11c). After reduction 263, sub-meshes 240a and 240b have no un-matched vertices (FIG. 11c). Combined sub-meshes 240a and 240b without cracks are ready for rendering 228.

FIG. 11a illustrates triangulation of rectangular sub-meshes 240a and 240b by adding a fan of triangles 300a-300l around a central vertex.

FIG. 11b illustrates the juxtaposition of sub-meshes 240a and 240b. Vertex 260 of sub-mesh 240a does not correspond to a vertex in sub-mesh 240a. Therefore, a crack (similar to cracks 350a-350c in FIG. 15b) will form.

Sub-mesh 240a is joined to sub-mesh 240b without cracks by stitching. Specifically, FIG. 11c illustrates stitching by vertex omission, vertex 260 is removed from sub-mesh 240a and triangles 300k and 300l (of FIG. 11b) are reduced to form triangle 300kl.

An alternative means of joining sub-mesh 240a to sub-mesh 240b is illustrated in FIG. 11d. Vertex 260 is added to sub-mesh 240b by splitting triangle 300h (of FIG. 11b) of sub-mesh 240b into triangles 300h1 and 300h2.

FIG. 12a illustrates a quadtree structure used for Rottger-Hiedrich triangulation. In a quadtree triangulation sub-mesh 240c is filled with quadrilaterals 310a-310p (as shown in FIG. 12a). Each Quadrilateral 310a-310p is filled with triangles surrounding a central vertex as illustrated in FIG. 11a. Finally, by vertex omission, as illustrated in FIG. 11c, cracks are removed from sub-mesh 240c as illustrated in FIG. 12b.

When joining quadtree sub-meshes by omitting vertices of triangles, it is not permissible to juxtapose two quadrilaterals differing in depth by a factor greater than two. An illegal quadtree structure is illustrated in FIG. 14. Quadrilateral 310d (of FIG. 12a) has been subdivided into four quadrilaterals 310d1-310d4. The quadrilateral 310a differs in subdivision depth by a factor of two in comparison to quadrilaterals 310d1 and 310d2. Therefore the juxtaposition is not permissible. Particularly, quadrilateral vertex 315 has no corresponding triangle vertex in quadrilateral 310a. Therefore quadrilaterals 310d1 and 310d2 cannot be joined to quadrilateral 310a.

FIG. 15a shows a 3D wire-frame illustration of a permissible Rottger-Hiedrich quadtree mesh 340a.

FIG. 15b show a 3D wire frame illustration of an impermissible Rottger-Hiedrich mesh 340b. Mesh 340b contains cracks 350a, 350b, and 350c.

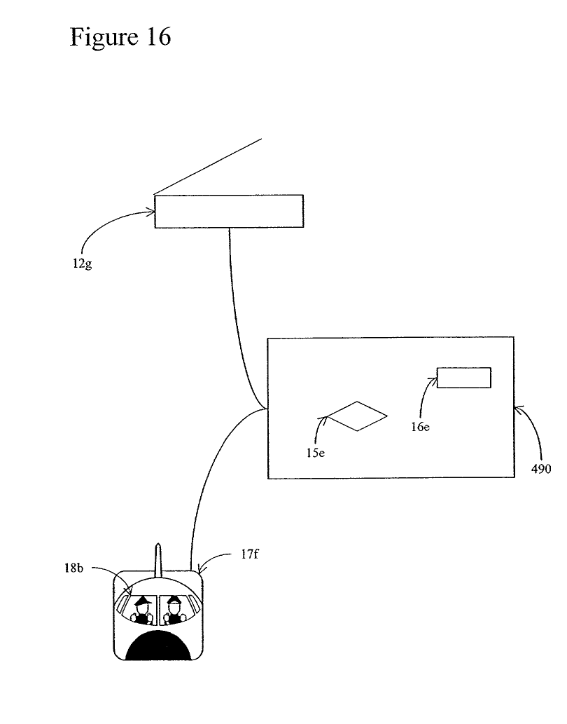

FIG. 16 illustrates a system for progressive meshing according to the present invention. Geographical data is manufactured from an aerial photograph on input interface 12g, for example a scanner, which digitizes the photograph data. The digitized data is input into computer 490 and stored in database 16e which exists on an internal hard drive of computer 490. Processor 15e (the CPU of computer 490) generates from the digitized data an optimal unstructured map and constructs from the digitized data a base polygon mesh. Processor 15e stores the optimal unstructured map and the base polygon mesh in database 16e. When simulation starts, processor 490 outputs the polygon mesh to output interface 17f (a flight simulator) to be projected onto simulator screen 18b.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for generating a syllabus for a trainee, the system comprising:
a) a database containing at least one topic and at least one topic attribute;
b) a processor in communication with said data base, said processor designed and configured to generate the syllabus based on said topic and topic attribute;
c) an input interface capable of communicating with said processor; and
d) an output interface capable of communicating with said processor.

2. The system of claim 1, wherein said input interface further includes at least one tool selected from the group consisting of a scenario builder, a device builder, a virtual instructor builder, a terrain builder, an import export algorithm and a certification tool.

3. The system of claim 1, wherein said database further stores trainee data and the syllabus is further based on said trainee data.

4. The system of claim 3, wherein said processor receives trainee performance data from training equipment, evaluates trainee performance and updates said database.

5. The system of claim 4, wherein said evaluation of performance is available to the trainee.

6. The system of claim 5, wherein said evaluation of performance includes an option to replay said exercise.

7. The system of claim 4, wherein said evaluation of performance is reported to an administrative user.

8. The system of claim 3, wherein said input interface includes at least one interface selected from the group consisting of a personal computer, formatted evaluations, an output channel of a training simulator, a medical database, a psychological database, a data collection device of a vehicle, a device measuring the performance of a vehicle, a voice communication device, an automated test reader, a personal digital assistant, a recording device, a scanner, and an e-mail message.

9. The system of claim 3, wherein said input interface serves at least one purpose selected from the group consisting of to edit said topic, to edit said topic attribute, to enter information pertaining to a budget, to edit information pertaining to resource availability, and to edit information pertaining to scheduling.

10. The system of claim 3, wherein said output interface serves at least one purpose selected from the group consisting of presenting a training exercise, presenting a training session program, presenting orders for a required resource, reporting progress, reporting budget information, and reporting schedule information.

11. The system of claim 3, wherein the syllabus includes a briefing.

12. The system of claim 3, wherein said trainee data includes at least one member of the group consisting of psychological data, an exercise previously completed by the trainee, time required by the trainee to complete said already completed exercise, previous experience of the trainee, and schedule information pertinent to the trainee.

13. The system of claim 1, wherein the syllabus contains a crew exercise, said crew exercise including a plurality of trainees.

14. The system of claim 13, wherein said plurality of trainees uses a plurality of output interfaces communicating via a network.

15. The system of claim 14, wherein the syllabus includes a mission and said plurality of input interfaces, said plurality of output interfaces and said network further serve to coordinate said mission.

16. The system of claim 1, wherein said database further stores at least one data item selected from the group consisting of a data library, a tutorial, a tip, a memo and a test.

17. The system of claim 16, wherein said memo requires reception verification by an intended recipient.

18. The system of claim 16, wherein said database further includes information pertinent to the trainee.

19. The system of claim 18, wherein said processor further pushes data to said output interface at an appropriate time.

20. The system of claim 1, wherein said attribute of said topic consist of at least one attribute selected from the group consisting of a topic level, an order in which said topics are to be covered, an exercise to train said topic, a prerequisite to performing said exercise, an estimated time needed by a typical trainee to complete said exercise, a resource required for said exercise, a resource availability, a budget information, a requisite for successful completion of said topic, and a requisite for successful completion of said exercise.

21. The system of claim 1, wherein said processor is a personal computer.

22. The system of claim 1, wherein said output interface consists of at least one interface selected from the group consisting of a video viewer, a training simulator, a training simulator control channel, voice instructions, a communication channel of a training vehicle, a control channel of a training vehicle, a printer, a personal digital assistant, an e-mail message, and a personal computer.

23. The system of claim 1, wherein the syllabus includes a program for a class, said class comprising a plurality of trainees.

24. The system of claim 1, further comprising:
e) a communication network in communication with said processor; and
f) a communication device in communication with said communication network to be used for at least one purpose selected from the group consisting of said data input interface, said output interface.

25. The system of claim 24, wherein said communication network is selected from the group consisting of the Internet, a cellular communication network, a telephone network, a computer network, a radio transmitter and receiver network and interconnected fax machines.

26. A method for generating a syllabus for a trainee, the method comprising the steps of:
a) providing a database containing at least one topic and at least one topic attribute;
b) generating the syllabus based on said topic and topic attribute in said database; and
c) outputting the syllabus.

27. The method of claim 26, further comprising the steps of:
d) inputting trainee data; and
e) updating the syllabus based on said trainee data.

28. The method of claim 27, wherein data is provided using at least one interface selected from the group consisting of a personal computer, formatted evaluations, an output channel of a training simulator, a medical database, a psychological database, a data collection device of a vehicle, a device measuring the performance of a vehicle, an automated test reader, a personal digital assistant, a recording device, a scanner, and an e-mail message.

29. The method of claim 27, wherein said trainee data includes trainee progress communicated to said database by training equipment.

30. The method of claim 27, wherein the syllabus includes a program for a class comprising a plurality of trainees.

31. The method of claim 27, wherein the step of providing said database includes at least one of sub-step selected from the group consisting of editing said topic, editing said topic attribute, entering information pertaining to a budget, editing information pertaining to resource availability, and editing information pertaining to scheduling.

32. The method of claim 27, wherein the step of outputting the syllabus includes at least one step selected from the group consisting of presenting a training exercise, presenting a training session program, presenting orders for a required resource, reporting progress, reporting budget information, presenting a crew exercise and reporting schedule information.

33. The method of claim 27, wherein said trainee data includes at least one member of the group consisting of psychological data, an exercise previously completed by the trainee, time required by the trainee to complete said already completed exercise, previous experience of the trainee, and schedule information pertinent to the trainee.

34. The method of claim 32, wherein said crew exercise is performed by a plurality of trainees using a plurality of input interfaces said input interfaces interconnected by a network.

35. The method of claim 26, further comprising the step:
d) providing information pertinent to the syllabus.

36. The method of claim 26, wherein said attribute of said topic consists of at least one attribute selected from the group consisting of a topic level, an order in which topics are to be covered, an exercise for training said topic, a prerequisite for performing said exercise, an estimated time to complete said exercise, a resource required for said exercise, a resource availability, a requisites for successful completion of said topic, and a requisite for successful completion of said exercise.

37. The method of claim 26, wherein the syllabus is generated by a personal computer.

38. The method of claim 26, wherein said output is provided by at least one interface selected from the group consisting of a video viewer, a training simulator program, a training simulator control channel, voice instructions, a communication channels of a vehicle, control channels of a training vehicle, and a printer.

39. The method of claim 26, wherein the syllabus includes a flight training exercise.

40. The method of claim 26, further comprising the steps of:
e) providing a communication network in communication with said processor; and
f) providing communication devices in communication with said communication network to be used for at least one purpose selected from the group consisting of inputting trainee data, inputting topic data, inputting attribute data and said step of outputting the syllabus.

41. The method of claim 40, wherein said communication network is selected from the group consisting of the Internet, a cellular communication network, a telephone network, a computer network, a radio transmitter and receiver network and interconnected fax machines.

42. A method of adaptive real time triangulation for progressive meshing of a domain based on a geometrical data set, the method comprising the steps of:
a) generating an optimal unstructured map based on the geometrical data;
b) storing said optimal unstructured map; and
C) constructing a polygon mesh in a section of the domain at a required level of detail based on said optimal unstructured map.

43. The method of claim 42, further comprising the step of:
d) modifying a location in said polygon mesh to meet a required level of detail.

44. The method of claim 43, wherein said steps of generating, storing and constructing are performed off-line and said step of modifying is performed repeatedly on-line according to need.

45. The method of claim 43, wherein said step of modifying a location in said polygon mesh includes at least one sub-step selected from the group consisting of splitting a polygon and reducing a plurality of polygons.

46. The method of claim 44, wherein for said step of splitting a polygon, the height of new vertices is assigned by at least one technique selected from the group consisting of kridging from known heights on said optimum unstructured map, interpolation of heights of said optimum unstructured map, interpolation of heights in said polygon mesh, hierarchical subdivision, and conditional random simulation.

47. The method of claim 44, wherein said splitting and said reduction of polygons is by the Rottger-Hiedrich algorithm.

48. The method of claim 42, wherein said geometric data is ground level data.

49. The method of claim 42, wherein said geometric data is digitized from a graphic image.

50. The method of claim 42, further comprising the step of:
d) rendering an image.

51. The method of claim 50, wherein said image is for use by a flight simulator.

52. The method of claim 42, wherein said step of generating an optimal unstructured map includes the sub-step of fitting a set of best-fit curves to the geometrical data.

53. The method of claim 52, wherein said set of best-fit curves are a set of splines.

54. The method of claim 52, wherein said step of generating an optimal unstructured map further includes the sub-step of creating a set of control points from said set of best-fit curves.

55. The method of claim 54, wherein said best-fit curves are Bezier splines; and said control points correspond to said set of Bezier splines.

56. The method of claim 42, wherein said step of generating an optimal unstructured map includes the sub-steps of:
i) breaking the domain into zones; and
ii) generating an optimal unstructured map in at least one of said zones.

57. The method of claim 56, wherein said zones are divided such that each zone has a consistent variance structure.

58. The method of claim 42, wherein said step of generating an optimal unstructured map includes the sub-step of sampling the geometrical data and wherein said optimal unstructured map is generated from said sample of said geometric data.

59. The method of claim 58, wherein a size of said sample of said geometric data is chosen based on scale of variance of the geometrical data.

60. The method of claim 42, wherein said step of generating an optimal unstructured map includes the sub-step of analyzing the scale of variance of the geometrical data.

61. The method of claim 60, wherein said analysis of scale of variance includes at least one analysis selected from the group including a Fourier analysis and spatial-statistical analysis.

62. The method of claim 61, wherein said variance structure is described by at least one characteristic selected from the list including a spectrum, a variogram, a covariogram, a fractal, and indicator statistics.

63. The method of claim 61, wherein conditional random simulation is used for at least one purpose selected from the group consisting of to simulate data in a location where the geometrical data is inadequate for said generation of said optimal unstructured map, to fill in data in a location where said optimal unstructured map is insufficient for said construction of said polygon mesh and to fill in data when modifying said polygon mesh in a location where said optimal unstructured map and said polygon mesh are insufficient for said required level of detail.

64. The method of claim 42, wherein said step of constructing a polygon mesh includes the step of triangulation.

65. The method of claim 64, wherein said step of triangulation is Delaunay triangulation.

66. The method of claim 42, wherein said step of constructing a polygon mesh includes the sub-step of simplifying at least one map selected from the group consisting of said optimal unstructured map and said polygon mesh.

67. A method of adaptive real time triangulation for progressive meshing of a domain based on a geometrical data set, the method comprising the steps of:
a) storing a geometric map of the domain;
b) constructing a polygon mesh in a section of the domain at a required level of detail based on said geometric map including the sub-steps of:
i) dividing the domain into a plurality of sub-domains;
ii) constructing a plurality of polygon sub-meshes, each polygon sub-mesh of said plurality of polygon sub-meshes being in one sub-domain of said plurality of sub-domains, each said polygon sub-mesh being based on said geometric map.
iii) joining a first sub-mesh of said plurality of sub-meshes to a second sub-mesh of said plurality of sub-meshes where said first sub-mesh and said second sub-mesh share a common boundary.

68. The method of claim 67, wherein said sub-step of joining is by stitching.

69. The method of claim 67, wherein said geometric map is an optimal unstructured map.

70. The method of claim 67, wherein said sub-step of dividing the domain into sub-domains is accomplished by employing at least one attribute selected from the group consisting of variance and required level of detail.

71. A system to progressively mesh a domain using adaptive real time triangulation comprising:
a) a processor designed and configured for:
i) generating an optimal unstructured map of the domain based on geometric data;
ii) constructing a polygon mesh of a portion of the domain at a required level of detail based on said optimal unstructured map; and
iii) modifying said polygon mesh to meet a new required level of detail
b) an input interface capable of communicating with said processor and designed and configured for inputting said geometric data;
c) a database capable of communicating with said processor and designed and configured for storing said optimal unstructured map and said polygon mesh; and
d) an output interface capable of communicating with said processor and designed and configured for outputting said polygon mesh.

72. The system of claim 71, wherein said processor is further designed and configured for breaking the domain into a plurality of sub-domains; generating a sub-mesh in each sub-domain and joining said sub-meshes.

73. The system of claim 71, wherein said processor is further designed and configured to analyze variance of said geometric data.

74. The system of claim 71, wherein said processor is further designed and configured to simplify at least one mesh selected from the group comprising said optimal unstructured map and said polygon mesh.

75. The system of claim 71, wherein said processor is further designed and configured to select sample of points from said geometric data.

76. The system of claim 71, wherein said processor is further designed and configured to fill in the geometrical data with simulated data in a location in the domain by conditional random simulation.

77. The system of claim 71, wherein said input interface includes a digitizer to manufacture said geometric data from a graphic image.

78. The system of claim 71, wherein said output interface is a flight simulator which uses said polygon mesh to render an image.
